(19) United States
(12) Patent Application Publication
(10) Pub. No.: US 2021/0072023 A1
(43) Pub. Date: Mar. 11, 2021

(54) APPARATUS FOR MEASURING A STRUCTURE AND ASSOCIATED METHOD

(71) Applicants: Ingo ANeumann, Hannover (DE); Hydromapper GnbH, Hamburg (DE)

(72) Inventors: Christian Hesse, Buxtehude (DE); Karsten Holste, Lauenhrueck (DE); Ingo Neumann, Hannover (DE)

(73) Assignees: Hydromapper GmbH, Hamburg (DE); Ingo Neumann, Hannover (DE)

(21) Appl. No.: 17/018,447

(22) Filed: Sep. 11, 2020

(30) Foreign Application Priority Data
Sep. 11, 2019 (DE) 10 2019 124 378.5

(51) Int. Cl. G01B 21/20

(52) U.S. Cl. CPC G01B 21/20; G01B 11/24

(57) ABSTRACT

A measuring apparatus for measuring a structure comprises at least one measurement sensor configured to measure the structure, a bearing platform configured to carry the at least one measurement sensor and a control. The control is configured to specify at least one quality reference value for at least one characteristic of measurement quality, and further configured to adjust one or more parameters of the measuring apparatus which influence the at least one characteristic of measurement quality. An actual quality value is determined and approaches the at least one quality reference value as the one or more parameters are adjusted.

### CROSS REFERENCE TO RELATED INVENTION

This application is based upon and claims priority to, under relevant sections of 35 U.S.C. § 119, German Patent Application No. 102019124378.5, filed Sep. 11, 2019, the entire contents of which are hereby incorporated by reference.

### TECHNICAL FIELD

The invention relates to a method for measuring a structure, in particular for purposes of damage assessment for the structure and construction monitoring. The invention also relates to a measuring apparatus for measuring the structure.

### BACKGROUND

The exterior contour of the structure in particular can be determined by such measurement of a structure. It can, for example, be applied in a structural inspection, particularly to investigate the structure for damage and/or deformations. Such investigations are performed on structures of the most diverse kind to identify in a timely manner damage which could, for example, endanger the structural integrity of the construct, and to facilitate the initiation of preventive measures.

The structure can, for example, be a hydraulic structure such as a bulkhead. Structural inspection of hydraulic structures includes structure checking, monitoring of construction and on-site structural inspection. Fundamentally, hydraulic structures can be inspected from land or from water, and inspection from water can include investigation of the structure above and below the water.

In land-based inspection, for example of mast structures, structure checks take place routinely with visual inspection by climbers, but also in individual cases using drones which produce corresponding images of the areas inspected. Further non-destructive test procedures which take place also include scanning of tunnel walls or local inspection of cable constructs on bridge structures. For this, digital test procedures are used constantly as a support for proximate inspection with human senses.

Examinations with human senses are also performed for structural inspections above water. This takes place in a manner essentially analogous to the land-based above-water inspection described. Structural inspection underwater is associated with significantly greater effort and expense. Examinations with human senses and damage surveys by divers underwater are subject to great variations in quality and quantity. It is in particular hardly possible to maintain a desired level of quality for the measurement, because the characteristics influencing quality cannot be controlled. Subjective perceptions result in a damage situation, damage classification and damage trends which are not reproducible in routine structural inspections. Moreover, area diving takes place only in special cases. Either the water in the structure can be pumped out and the investigation performed in a dry state or the construction parts found underwater are examined by diving at intervals of about 50 to 100 meters; in doing so, the diver slides down the structure and at the same time, under influences of currents, attempts to scan or, in the best case, perform visual inspection.

A measuring apparatus with a ship which pulls a bearing platform is known, for example, from JP 2012-032273 A. The bearing platform comprises sensors for examining an embankment both below and above water. Moreover, the bearing platform has a GPS antenna for determining position. DE 298 235 601 U1 discloses an arrangement for measuring profiles of waters in which a boat with an echo sounder measures the stretch of water and a tacheometer located on land also assigns position and height coordinates for the data collected by the echo sounder. A technical measuring device known from DE 295 059 301 U1 also works in a similar manner.

Moreover, to record objects such as structures, multi-sensor systems are frequently used; said systems combine various sensors for object recording and geo-referencing on a shared platform. For example, a mobile recording device which can be carried by a person is known from DE 10 2009 040 468 A1, which enables recording via a movable laser scanner. A vehicle equipped with multiple cameras is known from DE 10 2004 028 736 A1, in which the spatial coordinates of measurement points are determined based on location data from satellite positioning and position data are determined from the position of the measuring system in the area.

What the known methods and measuring apparatuses have in common is that they cannot ensure sufficiently high quality of the data collected. As the inventors have recognized, this is particularly due to the known methods and measuring apparatuses performing only uncontrolled measurement of the structure. In fact, in some cases a level of quality to achieve is specified prior to measurement, but maintaining said level cannot be ensured. This can lead in particular to variations in the quality of recordings which permit only an unreliable statement regarding damage found on the structure. Known methods or measuring apparatuses respectively also cannot ensure reproducibility of the measurement with repeated recording of the structure.

Starting from the prior art described, the task of the invention is to maintain a specified level of quality during measurement of the structure, in particular to achieve the best possible quality of measurement.

### BRIEF SUMMARY OF THE INVENTION

With the inventive method, a structure to be measured is measured using a measuring apparatus moving along the structure to be measured, where the measuring apparatus has at least one measurement sensor for measuring the structure and a bearing platform carrying the at least one measurement sensor. According to an embodiment of the method, at least one quality reference value is specified for at least one quality characteristic indicating the quality or standard of measurement, and during measurement one or more parameters influencing this quality characteristic are regulated such that the specified quality reference value is essentially achieved.

An embodiment of an apparatus comprises at least one measurement sensor for measuring a structure and a bearing platform carrying the at least one measurement sensor, in which further a control unit is configured to specify at least one quality reference value specified for at least one quality characteristic indicative for the measurement quality and to regulate during measurement one or more parameters influencing this quality characteristic such that the specified quality reference value is essentially achieved.

In an embodiment, the measuring apparatus is configured to perform the inventive method. The control unit of the measuring apparatus is particularly configured for performing the inventive method. The inventive method can consequently be performed with the inventive apparatus. The method and apparatus are explained together below. Explanations and embodiments described for the method also refer to the apparatus and vice versa.

In accordance with the invention, measuring a structure is fundamentally intended. The structure can be, for example, a structure close to water, such as a bulkhead or comparable embankments or port constructions. The bearing platform of the measuring apparatus can be buoyant, for example. Thus the measuring apparatus can be configured to measure the structure from the water. The at least one measurement sensor or at least one of the measurement sensors can be situated on a sensor platform. The sensor platform can be movable relative to the bearing platform, in particular be in a translational and/or pivotal manner in order to compensate undesired movements of the bearing platform during the measurement run among other things. To measure the structure, the bearing platform moves together with the at least one measurement sensor, i.e. in particular the entire measuring apparatus, along the structure. The bearing platform is thus configured to be movable for performing a measurement run. The bearing platform can have a dedicated drive, for example. Thus, for instance, the bearing platform can be a ship or boat. A separate drive unit can also be provided, such as a ship or boat which pulls the bearing platform behind it. The sensor platform can be decoupled from the bearing platform, for example via a hexapod or planetary gearing.

The bearing platform can generally be moved, for example, by a land vehicle, watercraft or aircraft, in particular an unmanned land vehicle, watercraft or aircraft. The watercraft can be a boat or ship, as mentioned, or also an underwater vehicle such as an unmanned submarine drone. The measuring apparatus can be configured to record the structure to measure from the water, from the air or from the road. The structure recorded can be in particular a building, a bridge, an embankment or port construction, a road or other structures as well. The at least one measurement sensor can be selected from the following: laser scanner, camera, in particular a thermal camera, range camera, echo sounder, multi-beam sensors or side-scan sonar. The laser scanner can in particular be a 2-D profile scanner or a 3-D scanner. The at least one measurement sensor can be situated below or above water with a watercraft as a bearing platform. If multiple measurement sensors are provided, some can be situated above water and others below water. A sensor situated underwater can measure the part of a bulkhead lying below water, for example. Multiple measurement sensors can be provided in particular. The measurement sensors can comprise a multi-sensor system as mentioned initially. The measuring apparatus can have at least one locating unit for determining a position and/or orientation of the measuring apparatus. The locating unit can be a receiving unit for a global navigation signal (GNSS) and/or an inertial measuring unit (IMU), for example. Thus the locating unit can be used particularly to determine the position in the area as well as the situation of the measuring apparatus, in particular of the sensor platform. In particular, the IMU provides the spatial angle, and the GNSS gives the azimuth angle and location. The location and situation data can be linked to the structural data of the structure recorded by the measurement, as already described above. The location data determined in particular by the locating unit can also be used to determine the speed as a first derivative and/or acceleration as a second derivative.

Measurement quality particularly indicates the quality of the structural data recorded, i.e. of the structural data. Measurement quality is defined by one or more quality characteristics. Quality or the quality characteristics can be understood particularly as a characteristic of measurement quality according to known DIN standards for measurement practices. In the present case, accuracy, precision, resolution, reliability, completeness or reproducibility of the structural data obtained from the structure recording are considered in particular to be quality characteristics. The time required for measurement can also constitute a quality characteristic. Quality results particularly from the combination of these quality characteristics. These quality characteristics are influenced by a plurality of parameters. Such a parameter influencing quality can be, for example, the spacing between the at least one measurement sensor and the structure or can also be the orientation of the at least one measurement sensor with respect to the structure.

In an embodiment, these parameters can be regulated such that the specified quality reference value is essentially or approximately achieved. Here, “essentially” means to a possibly specified tolerance value or tolerance range around the reference value. Overachievement of the reference value is also understood as achievement of the reference value. Regulation of the parameter can include that a reference value is specified for the parameter, an actual value of the parameter is determined during measurement, the actual value is compared to the reference value and, if there is a deviation between the actual value and the reference value, the parameter is regulated to the reference value. The quality reference value can be defined such that the best possible quality or even any desired level of quality is achieved for the respective use case. Also, according to one embodiment, multiple quality reference values can be specified for various quality characteristics indicating the measurement quality, and during measurement parameters influencing these quality characteristics can be regulated in such a way that the specified quality reference values are achieved.

For example, a resolution of 2 cm on structure can be specified as a quality reference value. Then the quality characteristic is therefore the resolution of the structural data. This resolution can be achieved, for example, up to a maximum spacing of 5 m between measurement sensor and structure, but at a greater distance that can no longer be ensured in some circumstances. If, for example, the bearing platform embodied as a boat were to drift farther than 5 m from the structure due to wind and current, the boat can be brought closer to the structure again by changing the azimuthal direction angle, doing so in fact until the resolution of 2 cm or better is once again achieved. Thus the distance between structure and measurement sensor can be regulated such that the quality reference value is achieved.

Also, according to one embodiment, if the at least one quality reference value is achieved beyond requirements, one or more additional quality characteristics indicating measurement quality can be optimized. Here, optimization is understood as the additional quality characteristic(s) being adapted such that in total a desired level of quality or best possible quality is achieved. For example, the spacing of the measurement sensor with respect to the structure can comprise 3 m although a spacing of 5 m would be possible to maintain a quality target of 2 cm for resolution. The spacing between measurement sensor and structure can then be enlarged and/or the operational speed of the bearing platform increased to facilitate faster recording (an additional quality characteristic) and to be able to release the structure to be investigated faster once again. Thus the quality characteristic for “recording time” can also be optimized. In another example, the accuracy is better required as a first quality characteristic than by the corresponding quality reference value. Completeness as a second quality characteristic can then be increased by more time-consuming inspection of the structure, or the recording time can be reduced by greater operational speed of the bearing platform. The converse applies likewise.

Thus the inventive measurement apparatus and method not only permits a quality level to be specified for measurement but can also ensure that said level be maintained. There is active intervention in the measurement process in order to achieve the quality reference value. In particular, the parameters influencing the respective quality characteristic are regulated until a current actual quality value determined reaches or exceeds the quality reference value within a defined tolerance. Then no further regulation is necessary. However, actual values can continue to be determined, and checking that the actual values correspond to the target value can continue. If a deviation occurs again, corresponding adjustment can take place once again.

In an embodiment, a control circuit can be provided for regulation in accordance with the invention. Thus regulation occurs in particular such a way that a specified quality is achieved, for example sufficiently high resolution of structural data. Regulation can also occur such that a best possible quality is achieved, for example a highest possible resolution of the structural data. Here in particular the standard deviation of an expected value or confidence range surrounding the expected value can serve as a measure of achieving a specified level of quality or the specified quality reference value respectively. A high measure of quality is particularly achieved when the standard deviation is as small as possible. The method can run with partial or, in particular, full automation. A quality reference value can first be specified manually. Subsequent regulation process for the parameters can ensue with full automation. As the inventors have recognized, the prior art methods and measuring apparatuses described above cannot maintain a specified level of quality because these do not systematically model and take into account the quality of recorded data but instead perform only uncontrolled measurement of the structure. Maintaining quality can be ensured by the inventive regulation of the parameters influencing quality to achieve the quality reference value, i.e. in particular the active orientation of the measurement sensors relative to the structure.

According to one embodiment, the at least one measurement sensor for regulating the parameter(s) is oriented and/or positioned automatically relative to the structure. The measuring apparatus can be configured accordingly. For example, the at least one measurement sensor can be adjusted relative to the bearing platform using actuators. The at least one measurement sensor or a sensor platform bearing the measurement sensor can, for instance, be adjusted in all six spatial degrees of freedom via a hexapod. The hexapod can be situated centrally on the bearing platform. An adjustment of the measurement sensor can also ensue via a pipe rod. The actuators enable the adjustment of the at least one measurement sensor, in particular in a translatory manner or also around one or more axes of rotation. Orientation of the at least one measurement sensor relative to the structure can take place in particular via tilting of the sensor relative to the structure on one or more axes of rotation. Positioning of the at least one measurement sensor relative to the structure can take place via translatory adjustment of the sensor relative to the structure, in particular in three dimensions. For example, using actuators, the sensor can be moved relative to the bearing platform, rising in a translatory manner, in the direction of movement of the bearing platform or contrary to said direction, and laterally perpendicular to said direction. The entire bearing platform can also be moved along with the sensor relative to the structure using a traction drive. Compliance with the quality reference value is achieved by the orientation and/or positioning of the measurement sensor in accordance with this embodiment. The measurement sensor need not be manually adjusted during measurement run to maintain the desired positioning or alignment relative to the object. The position of the at least one measurement sensor with respect to the structure can in particular include the distance between the at least one measurement sensor and the structure or the height position of the at least one measurement sensor relative to the structure. The position of the at least one measurement sensor with respect to the structure and the orientation of the at least one measurement sensor with respect to the structure can be understood here as the parameters influencing quality, as shall be explained below.

According to one embodiment, the quality of the measurement performed is determined based on the parameter(s). The control unit can be configured accordingly. In particular, the quality of the measurement performed, i.e. of the object data recorded as part of the measurement, can be determined already during the measurement based on the actual values of the parameters recorded as part of the measurement. For example, the actual values of the parameter can be recorded during the measurement process. The measuring apparatus can have a memory unit for this. Thus based on the actual values recorded, the actual measurement quality, i.e. one or more actual quality values for the quality characteristics, can already be determined in particular during measurement. Then a deviation can be determined between the respective actual quality value and the respective quality reference value and inventive regulation can take place until the actual quality value corresponds to the quality reference value. According to this embodiment, the quality of the recording of the structure, in particular an actual quality value for the quality characteristic, is calculated based on the at least one parameter, in particular based on a plurality of parameters influencing measurement quality. An influence function can be determined for each of the parameters, with said function describing the influence of the respective parameter on the quality characteristic and thus describing the quality. The actual values recorded can be used to determine the quality of structural data actually achieved. Thus it can be determined how close the actual quality achieved is to the quality required.

According to one embodiment, one or more of the following are envisaged as a parameter influencing measurement quality: position of the at least one measurement sensor with respect to the structure, spacing between the at least one measurement sensor and the structure, height position of the at least one measurement sensor relative to the structure, orientation of the at least one measurement sensor with respect to the structure, drift of the bearing platform, orientation of the bearing platform, operational speed of the bearing platform, acceleration of the bearing platform, scan rate of the at least one measurement sensor, measurement frequency of the at least one measurement sensor. The opening angle or the intensity measurement values of a multibeam can also be one such parameter which influences quality. Noise increases with a greater opening angle. Thus the inventively regulated parameters can be one or more of these parameters. Reference values for the parameter(s) can be derived from the specified quality reference value. If inventive regulation takes place for a plurality of the parameters, the reference values for the individual parameters can be defined, in particular also taking the other respective parameters into account. Thus, for example, a reference value for the distance between the measurement sensor and structure can be defined not only according to the quality characteristic of the greatest possible resolution of the structural data, but also based on an orientation of the measurement sensor to be achieved with respect to the structure. It can therefore make sense to specify a somewhat greater distance value as a reference value than would be desirable for ideal resolution if in so doing better orientation of the measurement sensor to the structure can be achieved, if in particular an orientation value specified as a reference value can be better achieved in this manner. Fundamentally, a sufficiently high resolution can be achieved as a quality reference value by regulation of the distance between measurement sensor and structure, for example. The resolution quality reference value can likewise be achieved by regulating the orientation of the sensor relative to the structure. Thus, for example, by regulating the orientation of the sensor, skewed recordings of the structure, i.e. in particular skewed angles of incidence for actively measuring sensors such as laser scanners or a multibeam, can be avoided or at least reduced. Such skewed recordings are frequently responsible for high noise and poor resolution. Moreover, influences of wind and waves can be taken into account by regulating the orientation of the sensor. If there is a floating bearing platform, wave action often results in difficulty maintaining the specified orientation of the measurement sensor(s) with respect to the structure. However, this can be achieved by the inventive closed-loop control. The inventive regulation of one or more of these parameters can automatically orient the at least one measurement sensor relative to the structure and/or position said sensor(s) relative to the structure, as described above. The position of the at least one measurement sensor with respect to the structure can in particular be a location in three dimensions. Here, the distance between the at least one measurement sensor and the structure and the height position of the at least one measurement sensor relative to the structure can be included in the location or be derivable therefrom.

According to one embodiment, for regulating the orientation of the at least one measurement sensor with respect to the structure, the measurement sensor, in particular a sensor platform with the measurement sensor, can be adjusted relative to the bearing platform around at least one axis of rotation and/or for regulating the height position of the at least one measurement sensor relative to the structure, the at least one measurement sensor, in particular a sensor platform with the measurement sensor, can have its height adjusted in a translatory manner relative to the bearing platform and/or for regulating the distance between the at least one measurement sensor and the structure, the at least one measurement sensor, in particular a sensor platform with the measurement sensor, can be adjusted laterally in a translatory manner relative to the bearing platform and/or the bearing platform can be moved toward or away from the structure by means of a drive. As already described, the measurement sensor or sensor platform respectively can be configured to be adjustable and/or pivotable in a translatory manner in each case relative to the bearing platform. In particular, the at least one measurement sensor or the entire sensor platform effectively can be situated to be pivotable around two or even three axes of rotation perpendicular to one another and/or adjustable around two or even three translational axes relative to the bearing platform. Thus the orientation of the sensor with regard to the structure or of the entire sensor platform with regard to the structure respectively can ensue around up to three perpendicular axes of rotation and the positioning around up to three translational axes. Orientation as a parameter can ensue by such pivoting of the sensor, in particular using the actuators already described, to achieve the quality reference value. The bearing platform can also be moved toward or away from the structure using a drive as described for regulating the distance between the at least one measurement sensor and the structure. As already described, the bearing platform itself can be actively powered; it can be a boat or ship, for example. The bearing platform can also be powered by a separate drive unit, for example a boat towing the bearing platform. This drive moving the bearing platform for measurement along the structure can also be used to move the bearing platform and thus the sensor platform toward or away from the structure. Fundamentally, however, an additional drive can also be provided for this. If the quality reference value is not achieved, corresponding corrective control takes place. Thus if, for example, the actual distance value is greater than that necessary to achieve the quality reference value, the bearing platform and thus the measurement sensor is moved toward the structure. If the actual distance value is less, the bearing platform is correspondingly moved away from the structure by means of the drive. The movement takes place until the quality reference value is reached once again.

However, aside from the distance described and the orientation of the measurement sensor relative to the structure, kinematic parameters for the bearing platform can also be important as parameters influencing measurement quality, as already described. Thus, for example, drift of the bearing platform can be regulated as a parameter. The operational speed or acceleration of the bearing platform can also be regulated as a parameter in the inventive manner. It can be important for the bearing platform to maintain a particular target speed for measurement to facilitate sufficiently high and in particular uniform resolution of structural data. However, due to influence factors of the most diverse kind, such as wind or even water movements, a deviation can occur from an operational speed once set as a reference value for the bearing platform. Thus an inventive regulation can also be expedient in these cases.

According to one embodiment, the at least one measurement sensor comprises at least one sensor emitting electromagnetic radiation or soundwaves, in which the orientation of the sensor with respect to the structure occurs such that the radiation or soundwaves emitted by the sensor strike the surface of the structure at a defined angle, in particular perpendicularly. The measurement sensor can be a laser scanner, for example, which directs laser radiation in an essentially linear manner onto the structure and detects laser radiation reflected by the structure. The inventive regulation can also take place here for orientation as a parameter so the laser beam impinges perpendicularly on the surface of the structure to record, i.e. of the structure. Skewed angles of incidence, which, as explained, can result in high noise in the structural data and in particular poor resolution of the structural data, are thus avoided. However, for particularly smooth surfaces it can be expedient to avoid perpendicularly incident radiation, because this can result in excessive radiation input to the sensor. Thus an angle deviating from a right angle can be particularly envisaged.

According to one embodiment, during measurement the position and/or situation of the measuring apparatus is determined in the space and assigned to the structural data recorded during measurement. This can take place in particular via the locating unit already discussed. Thus a receiving unit for a global navigation signal (GNSS), in particular GPS, and/or an inertial measuring unit (IMU) can be used, for example. A tacheometer directed at the measuring apparatus can also be used in determining the position, particularly if determining a position using the GNSS signal with sufficient reliability were not possible, for example due to shadowing effects.

According to one embodiment, the structure is measured multiple times and a structural change is identified by comparing the measurements. Such a structural change can be the occurrence and further progress of damage to the structure, for example. Multiple measurements can thus in particular measure the development of damage over time. Hence recordings of the structure from various periods can be compared to one another and thus ultimately a quality assured, reproducible and objective statement can be made regarding a structural change. The structural change can be present, for example, as tilting, torsion, position or height changes of the structure. In case of a trend in the damage, the progress of damage can be monitored in its size, depth, length and width. Above all, determining reference values for the parameters of the inventive regulation can ensue with even greater reliability based on multiple measurements. Structural changes can also necessitate adaptation of the reference values for the parameters.

According to one embodiment, the at least one quality reference value is used as the basis for route planning. Route planning concerns the definition of a route which the measuring apparatus is to travel along the structure or the structure respectively to measure the structure/structure. The measuring apparatus, thus ultimately the driven bearing platform, runs along the structure to measure the structure as explained. According to this embodiment, a route is defined for such a measurement run based on the quality reference value, said route enabling achievement of the quality reference value. The parameters influencing the quality characteristic are incorporated in route planning for this. Thus, as part of planning the route, the kinematic parameters exemplified for the bearing platform can be included in particular, i.e. in particular the bearing platform's speed as well as distance and orientation of the sensor or sensor platform respectively with respect to the structure among other things. For this, an influence function can be determined for each of the parameters, as already mentioned, with said function describing the influence of the respective parameter on the quality characteristic and thus describing the quality. The route can comprise a trajectory, i.e. a path of travel to be followed by the bearing platform expressed as location data for the bearing platform versus time, and also specifications for additional control variables. Thus according to one embodiment, the route can include specifications for one or more of the following control variables: trajectory of the bearing platform, operational speed of the bearing platform, acceleration of the bearing platform, orientation of the at least one measurement sensor with respect to the structure, the material and/or variables which account for the surface of the structure. The more control variables are incorporated in route planning, the greater the quality of the recording of the structure in the end. Thus some or several of the parameters described can be taken into account as part of route planning. For example, distance between measurement sensor and structure can be included as a parameter in the trajectory. Thus the specification of a defined distance between structure and object can be conducive to achieving the quality reference value. In addition to the parameters exemplified, the material or the surface of the structure to investigate respectively can be included as part of route planning. For example, the planned route can comprise specifications for the orientation of the measurement sensor relative to the structure. For instance, the orientation can be specified in such a way that, as far as possible throughout the entire route, radiation emitted by the measurement sensor impinges upon the surface of the structure at a defined angle. This can be a right angle, for example, as explained above. For sections of the structure with a particularly smooth surface, an angle can be specified which deviates from a right angle in order to avoid excessive radiation input to the sensor.

According to one embodiment, as part of route planning, and area of movement for the bearing platform which surrounds the structure is subdivided into sectors of various measurement quality, with the planned route placed through the sectors which permit achieving the quality reference value to be expected. To define an optimal route for the measurement run, the possible areas for the trajectory, i.e. the travel corridor for the bearing platform, can be subdivided according to their quality based on the respective parameters. Thus sectors in the area of movement around the structure can result which enable better quality of measurement to be expected than in other sectors. In particular, the route can then be placed through the sectors in such a way that the specified quality reference value and thus a specified level of quality, in particular a highest possible quality of measurement, are achieved. The division into sectors can be done, for example, with sectors for which various qualities of measurement can be expected have different colors or shadings. For example, sectors for which higher measurement quality is expected can be indicated by green and sectors for which lower measurement quality is expected can be indicated by red. Sectors for which higher measurement quality is expected can also be indicated by a single color or white and sectors for which lower measurement quality is expected can be indicated by stippling. A selective calculation of quality levels to be achieved can also be performed, in particular based on a standard deviation defining the quality. For example, a grid can be produced for the measurement accuracy to expect as quality, with a route being planned such that the standard deviations for the respective accuracy value are as low as possible.

According to one embodiment, the route specifies a bearing platform trajectory; during measurement, the actual trajectory is compared to the specified trajectory, and in case of a deviation of the actual trajectory from the specified trajectory, the trajectory is regulated to the specified trajectory. Thus in particular automatic regulation can ensue to follow the planned route. This can occur by regulating the parameters specified as part of route planning in the inventive manner. For example, as part of route planning, a trajectory can be defined for each of the sectors which provides a particular orientation of the sensor and a particular distance of the sensor with respect to the structure. The planned values for these parameters can be the same in each case in some sectors, but can also differ in each sector. For example, for one sector it can be expedient to bring the measurement sensor closer to the structure to be recorded in order to achieve a desired orientation of the sensor with respect to the structure. In a sector following that one, it can in turn be expedient to increase the distance between the sensor and structure. Regulating the trajectory to the specified trajectory can enable particularly good compliance with the latter. For this, the platform can, for example, have three underwater drives and thus vary not only the location but also the orientation.

### BRIEF DESCRIPTION OF THE DRAWINGS

One embodiment of the invention is explained below using figures below where:

FIG. 1 illustrates a perspective view of an embodiment of a measuring apparatus;

FIG. 2 illustrates the embodiment of the measuring apparatus of FIG. 1 performing measurements of a bulkhead;

FIG. 3 illustrates a schematic view of a trajectory defined for the measuring apparatus as part of route planning; and

FIG. 4 illustrates measurement of a bulkhead and of a water body substrate by the measuring apparatus in multiple runs.

If not otherwise specified, the same reference numbers indicate the same objects below.

### DETAILED DESCRIPTION OF THE INVENTION

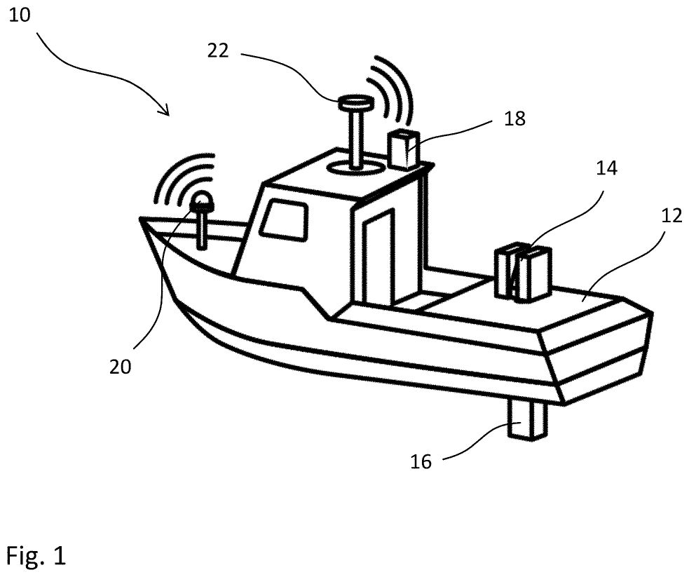

FIG. 1 shows an embodiment of a measuring apparatus 10 for measuring a port construction. The measuring apparatus 10 comprises a buoyant bearing platform 12 in the form of a boat, a scanner above water 14, a scanner below water 16, a camera 18 and a GNSS receiving unit 20. The scanners and camera 14, 16 and 18 include measurement sensors 14, 16, 18 that are used for measuring a structure. The measurement sensors 14, 16, 18 can be arranged in a manner not depicted on a shared sensor platform. Furthermore, a reflector 22 is situated on the bearing platform 12. The measuring apparatus 10 also has a drive, not shown and situated on the bearing platform, with which the bearing platform 12 is actively powered and thus able to be moved along a structure for a measurement run.

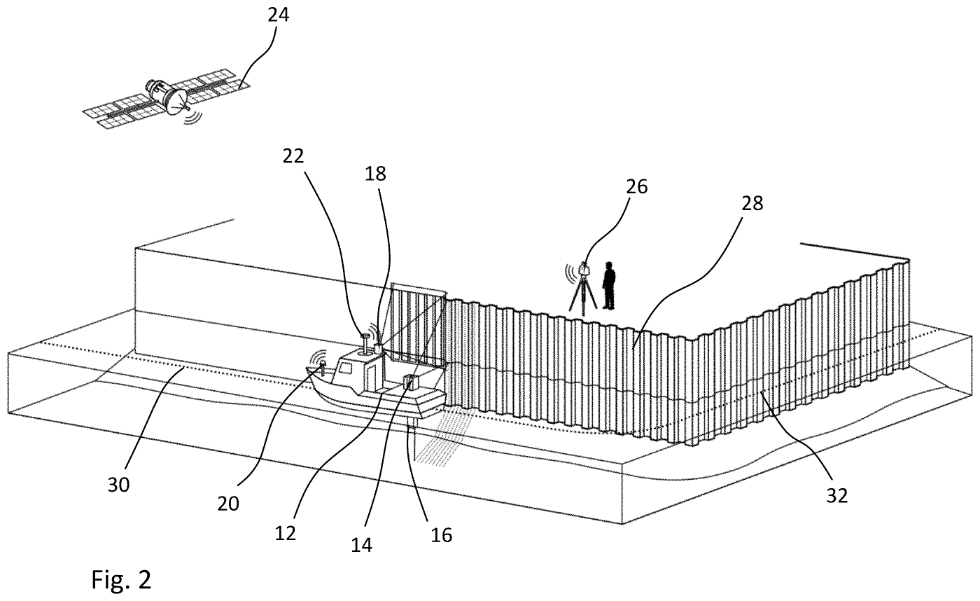

FIG. 2 shows the measuring apparatus 10 during measurement of a structure close to water, specifically a bulkhead 28 in the present case. There is also a tacheometer 26 situated on land. The tacheometer 26 is directed at the reflector 22 of the bearing platform 12. However, the tacheometer is fundamentally optional and in particular not required for the inventive method. The Tacheometer can be used if the GNSS signal provides no precise data due to shadowing effects, for example. The measuring apparatus 10 moves along the bulkhead 28 on a trajectory 30 and investigates said bulkhead with its measurement sensors 14, 16, 18. The area of the bulkhead 28 already measured is visible with a three-dimensional structure in FIG. 2. During their measurement, the measurement sensors 14, 16, 18 record structural data for the bulkhead, such as damage, in a manner generally known. Thus, for example, the sensors 14, 16, 18 can be laser scanners which can provide information on the relief from the signal transit times and information on the surface condition of the bulkhead from reflection data as structural data. The sensor or scanner 16 can also be an echo sounder providing corresponding data. The sensor 18 can be a camera providing color images of the bulkhead. The structural data determined by the sensors 14, 16, 18 can be associated with location data for the bearing platform 12 via a control unit. The GNSS receiving unit 20, which receives GNSS signals from satellites 24 of a global navigation satellite system in a manner generally known, is used for determining the location of the bearing platform 12, as is an inertial measuring unit, which is not shown. The tacheometer 26 can also be used to determine the position of the measuring apparatus 10, in particular if the GNSS signal is not available.

The specified trajectory 30 was defined as part of planning the route. This trajectory was defined based on a preferred level of quality to achieve for the measurement. This level of quality is influenced by multiple quality characteristics, with a quality reference value having been specified for at least one of the quality characteristics. The distance of one or more of the measurement sensors 14, 16, 18 with respect to the bulkhead 28 is included particularly for this in planning the route and thus the trajectory as a parameter influencing measurement quality. Here a distance of the measuring apparatus and thus of the respective sensors from the bulkhead 28 is regulated during the run of the measuring apparatus 10 along the bulkhead such that the quality reference value is achieved. The measuring apparatus 10 is maintained at a predefined distance with respect to the bulkhead 28 along the specified trajectory 30. Ultimately, compliance with the planned route is regulated in this way. Thus the actual trajectory 32 which is in fact followed by the measuring apparatus 10 can be kept as close as possible to the specified trajectory 30.

Particularly reliable and reproducible measurement is accomplished by maintaining this trajectory and thus the specified parameters. In particular, quality assured recording of the structure can be ensured this way. For this, and influence function which describes the influence of the parameter on quality is defined for each of the parameters.

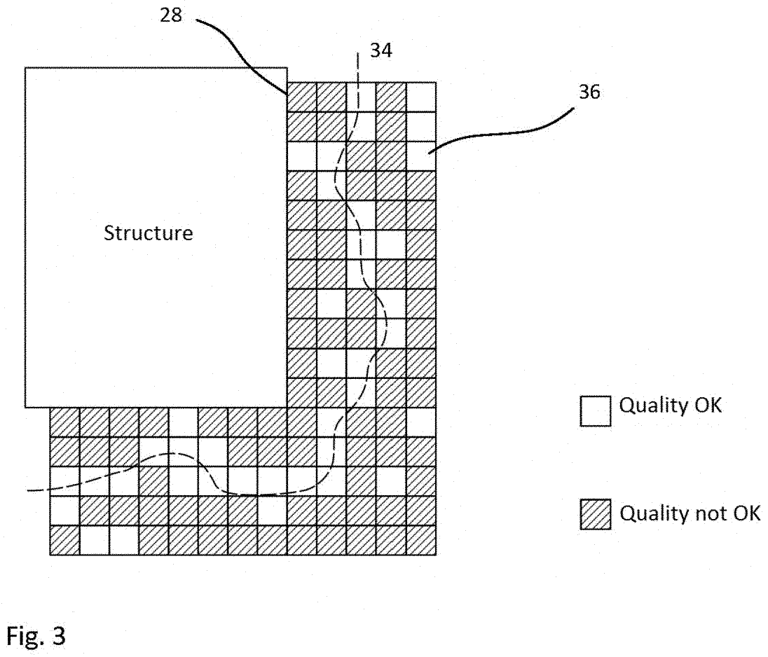

Additional parameters can be incorporated in route planning. In particular, these parameters can also be regulated in the inventive manner such that the quality reference value is achieved. Along with the distance of the sensors and thus of the measuring apparatus from the bulkhead as already described, this can also be the orientation of the sensors with respect to the bulkhead. For instance, the speed or acceleration of the bearing platform and orientation of the bearing platform can also comprise such parameters. Specified values are defined initially for the parameters to be regulated based on empirical values or estimated values. Referring to FIG. 3, a trajectory 34 to be followed is defined as part of route planning based on these specified values. This can subdivide an area of movement for the bearing platform into sectors 36 of various measurement quality around the bulkhead, as seen in FIG. 3. The top view in FIG. 3 shows the sectors 36 as square area elements. In the present case, the sectors are divided into various measurement qualities in a binary manner, specifically for sufficient quality on one hand and insufficient quality on the other. The specified quality reference value can be achieved in the sectors with “sufficient quality”. The trajectory 34 is set in the course of planning the route such that as far as possible only or at least as many sectors as possible with sufficient measurement quality are passed through.

For example, as already mentioned, the distance of the measuring apparatus with respect to the bulkhead and the orientation of the measurement sensors with respect to the bulkhead can be incorporated as parameters influencing quality. In defining the trajectory, the attempt is made to achieve the highest possible total quality, for example to achieve a specified quality or a highest possible quality. Since the objective of this is to achieve a particular quality overall via all parameters, it can be expedient, at least in sections, to specify a reference value for one of the parameters which is rather suboptimal insofar as this allows an optimal reference value to be specified for another parameter. For example, by varying the distance of the measuring apparatus with respect to the structure along the trajectory as shown in FIG. 3. This can be expedient, because perhaps only in this way can a desired orientation of the sensors with respect to the bulkhead surface be ensured. In particular, this can possibly ensure that the sensors comprised as lasers scanners impinge a beam path perpendicularly upon the structure's surface.

In accordance with the invention, these parameters can be regulated during the measurement run such that the specified quality reference value is achieved. For example, a resolution of 2 cm on the bulkhead 28 can be specified as a quality reference value. Then the quality characteristic is therefore the resolution of the structural data. This resolution can be achieved up to a maximum spacing of 5 m, for example, between measurement sensor 18 and bulkhead 28, but at a greater distance that can no longer be ensured in some circumstances. If, for example, the bearing platform 12 were to drift farther than 5 m from the bulkhead 28 due to wind and current, the bearing platform 12 can be brought closer to the bulkhead 28 again by changing the azimuthal direction angle, doing so in fact until the resolution of 2 cm or better is once again achieved. Thus the distance between bulkhead 28 and measurement sensor 18 can be regulated such that the quality reference value is achieved.

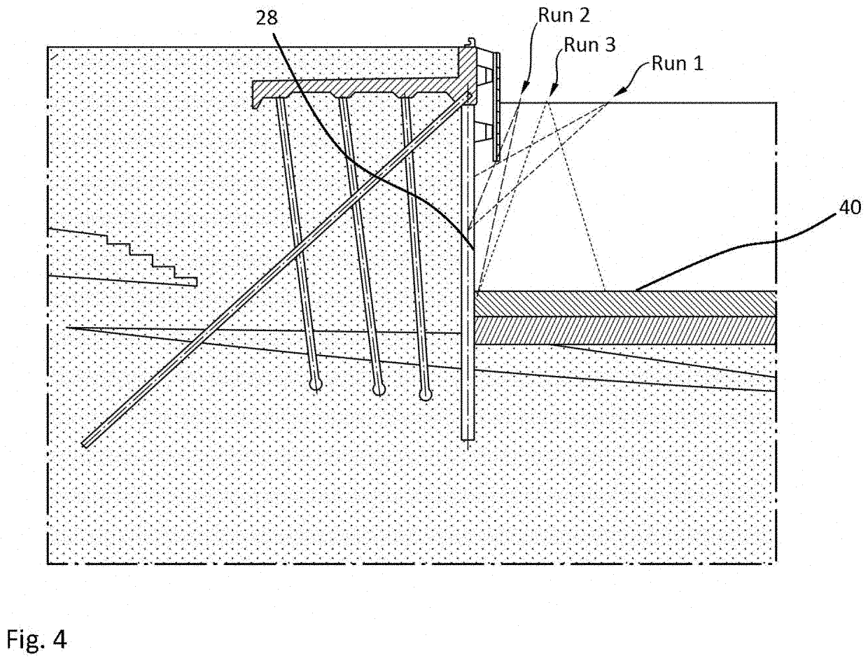

A structure to be investigated can also be scanned in multiple runs. As seen in FIG. 4, the bulkhead 28 underwater and a water body substrate 40 can be scanned by orienting the sensor 16 differently. Thus three measurement runs can be provided, in which a section of the bulkhead 28 situated farther above is measured in a first measurement run, the section of bulkhead thereunder is measured in a second measurement run, and finally the adjacent area of the water body substrate is measured in the third run. Regulation of the parameters influencing the measurement quality can take place in the inventive manner for all these runs.

1. A method for measuring a structure to assess for damage and monitor construction, the method comprising:
providing a measuring apparatus configured to move along the structure, the measuring apparatus comprising,
at least one measurement sensor, and
a bearing platform configured to carry the at least one measurement sensor;
measuring the structure using the at least one measurement sensor;
determining one or more parameters of the measuring apparatus;
specifying at least one quality reference value for at least one quality characteristic, wherein the at least one quality reference value indicates a desired level of quality for the measuring of the structure; and
adjusting the one or more parameters during the measuring to achieve the at least one specified quality reference value, wherein the one or more parameters influence the at least one quality characteristic.

2. The method according to claim 1, wherein the at least one quality characteristic comprises at least one of accuracy, precision, resolution, reliability, completeness, reproducibility of structural data of the structure acquired by measurement, and time required for completion of the measurement.

3. The method according to claim 1, wherein the at least one measurement sensor is configured to automatically regulate the one or more parameters relative to the structure and is positioned relative to the structure.

4. The method according to claim 1, wherein the one or more parameters influencing the at least one quality characteristic comprises at least one of position of the at least one measurement sensor with respect to the structure, spacing between the at least one measurement sensor and the structure, height position of the at least one measurement sensor relative to the structure, orientation of the at least one measurement sensor with respect to the structure, drift of the bearing platform, orientation of the bearing platform, operational speed of the bearing platform, acceleration of the bearing platform, scan rate of the at least one measurement sensor, and measurement frequency of the at least one measurement sensor.

5. The method according to claim 4, wherein the at least one measurement sensor is configured to be adjusted relative to the bearing platform.

6. The method according to claim 5, wherein the at least one measurement sensor is configured to rotate relative to the bearing platform around at least one axis of rotation.

7. The method according to claim 6, wherein the at least one measurement sensor is configured to be adjusted in height and in a lateral direction in a translatory manner relative to the structure and relative to the bearing platform, and wherein the bearing platform further comprises a drive configured to move the bearing platform toward and away from the structure.

8. The method according to claim 7, wherein the at least one measurement sensor emits one of electromagnetic radiation and soundwaves, and wherein the at least one measuring sensor is orientated with respect to the structure such that the one of radiation and soundwaves emitted by the sensor strike a surface of the structure at a 90° angle.

9. The method according to claim 8, wherein during the measurement of the structure, a position of the measuring apparatus is determined and assigned to structural data recorded during measurement.

10. The method according to claim 1, wherein the structure is measured multiple times and a structural change is determined by comparing the multiple measurements.

11. The method according to claim 1, wherein the at least one quality reference value is used for planning a route.

12. The method according to claim 11, wherein the planned route includes specifications for one or more control variables, wherein the one or more control variables comprise at least one of trajectory of the bearing platform, operational speed of the bearing platform, acceleration of the bearing platform, orientation of the at least one measurement sensor with respect to the structure, a control variable related to a material and a control variable which accounts for a surface of the structure.

13. The method according to claim 11, wherein the rout planning comprises subdividing an area of movement for the bearing platform which surrounds the structure into sectors of various measurement quality, wherein the planned route is placed through the sectors which achieve at least the specified quality reference value.

14. A method for measuring a structure using a measuring apparatus moving along the structure to be measured, the method comprising:
measuring the structure using at least one measurement sensor of the measuring apparatus;
providing at least one quality reference value for at least one characteristic of measurement quality;
determining one or more parameters of the measuring apparatus, wherein the one or more parameters influence the at least one characteristic of measurement quality;
determining an actual quality value based on the one or more parameters; and
regulating the one or more parameters so the determined actual quality value approaches the at least one quality reference value.

15. A measuring apparatus for measuring a structure, the measuring apparatus comprising:
at least one measurement sensor configured to measure the structure;
a bearing platform configured to carry the at least one measurement sensor; and
a control configured to specify at least one quality reference value for at least one characteristic of measurement quality and to adjust one or more parameters of the measuring apparatus which influence the at least one characteristic of measurement quality,
wherein an actual quality value is determined and approaches the at least one quality reference value as the one or more parameters are adjusted.

16. The measuring apparatus according to claim 15, wherein the bearing platform is moved by one of a land vehicle, a watercraft, and an aircraft.

17. The measuring apparatus according to claim 15, wherein the at least one measurement sensor comprises at least one of a laser scanner, a camera, an echo sounder, a multi-beam sensor, and a side-scan sonar.

18. The measuring apparatus according to claim 15, further comprising at least one locating unit configured to determine a position of the measuring apparatus.
